(19) United States
(12) Patent Application Publication
(10) Pub. No.: US 2025/0190619 A1
(43) Pub. Date: Jun. 12, 2025

(54) METHOD AND SYSTEM FOR PERSONAL IDENTIFIABLE INFORMATION REMOVAL AND DATA PROCESSING OF HUMAN MULTIMEDIA

(71) Applicant: Neufast Limited, Pak Shek Kok, NT (HK)

(72) Inventors: Ning LI, Pak Shek Kok, NT (HK); Hai Xiang LEE, Pak Shek Kok (HK)

(21) Appl. No.: 18/847,405

(22) PCT Filed: Apr. 27, 2023
(86) PCT No.: PCT/CN2023/091056

§ 371 Date: Sep. 16, 2024

Related U.S. Application Data
(60) Provisional application No. 63/335,756, filed on Apr. 28, 2022.

(51) Int. Cl. G06F 21/62; G06V 10/82; G06V 40/16; G06V 40/20

(52) U.S. Cl. CPC G06F 21/6245; G06V 10/82; G06V 40/176; G06V 40/20

(57) ABSTRACT

A method for processing personal video and audio data. The method includes the steps of receiving an original video data. extracting video frames and an audio from the original video data, identifying PII features as well as non-PII features in both the video frames and the audio: extracting the non-PII features from the video frames and the audio: using the extracted non-PII features to compose a converted video data: and outputting the converted video data. The method allows the PII from the videos, audio or images to be removed but keeps non-PII features and allows the risks of storage to be significantly reduced.

### FIELD OF INVENTION

This invention relates to data privacy, and in particular to removal of Personal Identifiable Information (PII) from human-related data.

### BACKGROUND OF INVENTION

In the information era there is a growing use of human-related data by many industries for example for online services, machine learning and compliance. The human-related data refers to any data that is partially or wholly related to one or more person, and the human-related multimedia data could be in the form of videos, images, audios, and texts of humans or their combinations, such as CCTV videos, social media videos, video conferences, and video interviews. However, because of the sensitivity of human-related video/audio data, some people worry about taking pictures or recording videos online or being recorded by CCTVs. This limits the use of many beneficial applications of videos in the society. On the other hand, in many data sensitive digital online industries such as banking, insurance, human resources, healthcare, security, and governments, there is also a need to satisfy stringent data security and compliance requirements.

Human-related multimedia data typically contain both PII such as the facial/body/wearables and audio characteristics of the human, environmental background of the video, and non-personal identifiable information (non-PII) such as affect, emotion, facial expression, voice pitches and intensity. With a fast-growing emphasis on data privacy and ESG (environment, social and governance) across the world, there is a need for PII removal from the human-related data, while maintaining non-PII information. However, although there were attempts to conduct a PII-only removal of features, some conventional methods lose part or all of non-PII features (e.g. emotion and facial expression) which are often the significant clues in human behavior research, consumer behavior study, customer service, job and presentation training, job candidate assessments, etc.

On the other hand, for machine learning models that focus on identifying non-PII, the existence of PII in the same multimedia can be a source of human bias and information security risk. Existing methods to reduce bias in data annotation are human-centric, and they are only half effective and subjective.

### SUMMARY OF INVENTION

Accordingly, the present invention, in one aspect, is a method for processing personal multimedia data. The method includes the steps of receiving original video data, extracting video frames and an audio from the original video data, identifying PII features as well as non-PII features in both the video frames and the audio; extracting the non-PII features from the video frames and the audio; using the extracted non-PII features to compose converted video data; and outputting the converted video data.

In some embodiments, the step of identifying the PII features and the non-PII features further contains detecting one or more of a face and a body characteristic from the video frames.

In some embodiments, the step of extracting the non-PII features from the video frames and the audio further includes encoding a detected face or a detected body characteristic, and learning the detected face or the detected body characteristic.

In some embodiments, the step of learning the detected face or the detected body characteristic further includes learning an affect of the detected face, learning an emotion of the detected face, or learning a facial expression of the detected face.

In some embodiments, the detected body characteristic contains one or more of a body motion, a posture, a gesture, clothing, and wearables.

In some embodiments, the step of using the extracted non-PII features to compose converted video data further includes generating a designated face based on a detected face, or a designated body characteristic based on a detected body characteristic; and composing the converted video data based on the designated face or the generated body characteristic.

In some embodiments, the designated face is generated using a neural network as an encoder-decoder structure.

In some embodiments, the step of using the extracted non-PII features to compose converted video data further includes generating an avatar face; applying non-PII features of the face to the avatar face; and composing converted video data based on the avatar face and/or the generated body characteristic.

In some embodiments, the step of identifying PII features as well as non-PII features in both the video frames and the audio, includes transcribing the audio into a textual transcription; detecting the PII features from the audio and the transcription; and learning an audio feature from the audio.

In some embodiments, the audio feature is pitch, intensity, speed or fluency of speech.

In some embodiments, the step of using the extracted non-PII features to compose converted video data further includes composing the converted video data using designated face, avatar, portrait, background, and human voice.

In some embodiments, the method further includes the step of performing data annotation on the converted video data by a multi-modal data annotation module.

According to another aspect of the invention, there is provided a system for processing personal video data. The system contains at least one processor, and a non-transitory computer readable medium comprising instructions that, when executed by the at least one processor, cause the system to perform: receive original video data, extract video frames and an audio from the original video data, identify PII features as well as non-PII features in both the video frames and the audio, extract the non-PII features from the video frames and the audio, using the extracted non-PII features to compose converted video data; and outputting the converted video data.

According to another aspect of the invention, there is provided a non-transitory computer-readable medium including instructions that, when executed by at least one processor, cause a computer system to receive original video data, extract video frames and an audio from the original video data, identify PII features as well as non-PII features in both the video frames and the audio, extract the non-PII features from the video frames and the audio, using the extracted non-PII features to compose converted video data, and outputting the converted video data.

One can see that embodiments of the invention provide systems and methods to remove PII from human-related data, by converting human-related video and audio into videos and audios with designated human or character (real or animated) and voices, while keeping the non-personal (non-PII) information. In some embodiments, protection of PII associated with human video, image, audio, and transcription is achieved by removing, converting, obfuscating, and generating video, image, and audio with set(s) of the designated face, avatar, portrait, background, and human voice as well as PII-removed transcription, while keeping non-PII information. Using the conversion system and processes, PII information is fully or selectively removed. The risk of data leakage to the privacy of the human can be substantially reduced.

Thus, embodiments of the invention provides a reduced risk in storing, presenting, and transferring human videos, audios and images; enhancement of the accuracy and elimination of human bias in data annotation, training and inferences of machine learning models; and reduced the risk of exposing personal information from trained machine learning models. The converted video and audio can be safely stored and used, leading to potential satisfactions of regulations and opening up new applications. For example, the generated data is processed for data storage and transfer, data presentation, data sharing, data analysis, data annotation, machine learning, machine interference, and other potential usages that need the protection of PII and the use of depersonalized data. Data annotation or artificial intelligence developed using the converted video/image and audio for human behavior has much higher quality as the potential human bias due to personal information such as appearance and gender in the original video is eliminated. Studies and modeling can also be performed on the converted video to provide objective information on human behavior.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 is a schematic overview of a data processing infrastructure including a data processing system, according to a first embodiment of the invention.

FIG. 2 shows a general method flow of removing PII from personal video data, according to another embodiment of the invention.

FIG. 3 illustrates an exemplary module and associated method steps for non-PII facial feature learning in the method of FIG. 2.

FIG. 4 illustrates an exemplary module and associated method steps for generating a designated face or controlling an avatar in the method of FIG. 2.

FIG. 5 shows an exemplary machine learning model and associated method steps for training the machine learning model for generating the designated face.

FIG. 6 shows an exemplary module and associated method steps for gesture and posture feature learning in the method of FIG. 2.

FIG. 7 illustrates an exemplary module and associated method steps for gesture generation, avatar controlling, and image composition in the method of FIG. 2.

FIG. 8 shows an exemplary machine learning model and associated method steps for training the machine learning model used for generating the gesture and posture.

FIG. 9 illustrates a module for PII speech removing and voice feature learning and associated method steps in the method of FIG. 2.

FIG. 10 illustrates an exemplary module and associated method steps for designated voice generation in the method of FIG. 2.

FIG. 11 shows an exemplary machine learning model and associated method steps for training the machine learning model used for designated voice generation in the method of FIG. 2.

FIG. 12 illustrates shows a general method flow of a multi-modal data annotation tool and associated method steps, according to another embodiment of the invention.

FIG. 13 shows an example of the interface of a PII-removed multi-modal data annotation tool, according to another embodiment of the invention.

In the drawings, like numerals indicate like parts throughout the several embodiments described herein.

### DETAILED DESCRIPTION

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to electrical coupling, connection, and/or data communication either directly or indirectly via one or more electrical means unless otherwise stated.

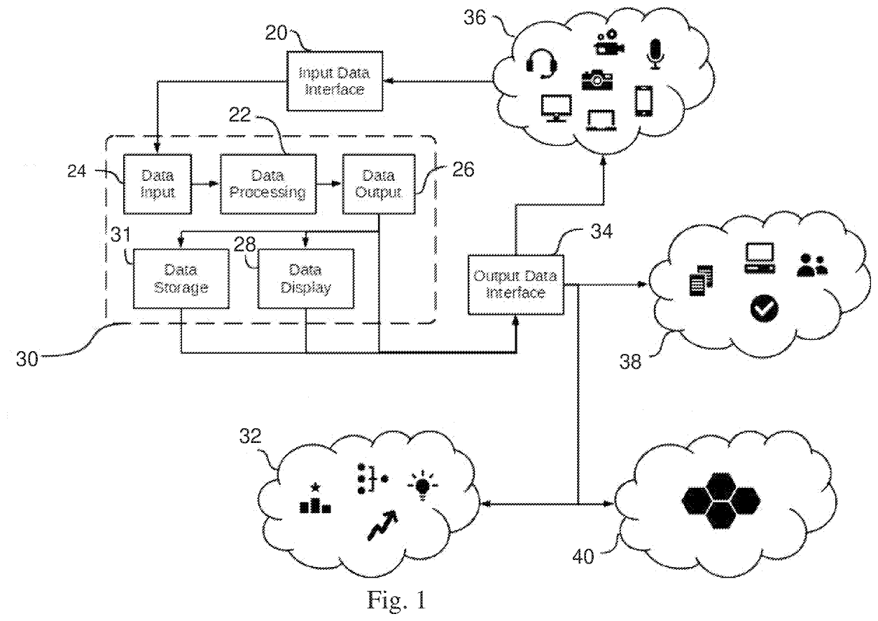

Referring now to FIG. 1, in a first embodiment of the invention there is provided a data processing system 30 which is suitable for removing part or all of PII from human-related data. The purpose of the system 30 is to remove the PII which can be a source of human bias and information security risk within the human-related data, and also to keep non-PII features such as affect, emotion, facial expression, gesture, posture, voice pitch and intensity, and speed/fluency of speech for post-processing. In this regard, FIG. 1 shows not only the data processing system 30 but also I/O interfaces for the system 30, as well as some post-processing devices or modules that utilize output data from the data processing system 30. In particular, the system 30 contains a data input module 24 that is connected to an input data interface 20 which in turn is adapted to receive original data to be processed from data collecting device 36. The data collecting device 36 is adapted to transmit human-related data as the original data to the input data interface 20, and the data collecting device 36 could be any type of physical or virtual device such as a database, a hard disk, smartphones, notebook computers, tablets, web cameras, voice recorders, microphones, desktop computers, security cameras, Internet-of-Things and closed-circuit television system. There could be more than one data collecting devices 36 that collaboratively provide human-related data as the original data to the data processing system 30, for example a voice recorder providing audio data, and a camera simultaneously providing video data. The input data interface 20 is any physical or virtual data interface that facilitate inputting video, audio, text, image, etc. to the data input module 24 of the data processing system 30, and examples of the input data interface 20 include Wi-Fi, cellular network, Bluetooth, USB ports, IEEE 1394 ports, serial ports, etc.

The data input module 24 serves as an input of the data processing system 30, and is connected to a data processing module 22 which is the core part of the data processing system 30. The data processing module 22 is based on Artificial Intelligence (AI), and are implemented over hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks. The data processing module 22 is connected to a data output module 26 which serves as the output of the data processing system 30. From the data processing module 22, converted data with part of all of PII information contained in the original data removed, may be outputted to different devices such as a data storage device 31, a data display device 28, and an output data interface 34. The data storage device 31 and the data display device 28 in this embodiment are part of the data processing system 30 and they are used for storing the output data and displaying the output data (to a user) respectively. The output data interface 34 on the other hand is similar to the input data interface 20 and can be any physical or virtual data interface that facilitate outputting video, audio, text, image, etc. to an external device. As shown in FIG. 1, the output data interface 34 is connected to the data collecting device 36, a data annotation tool 38, machine learning model(s) 32, and other device(s) application(s) 40. As such, for the data collecting device 36 one can see it both provides the original data to the data processing system 30 and receives converted data (i.e., the output data) from the data processing system 30. Thus, a user of the data collecting device 36 may submit original video data to the data processing system and receive converted data from the latter. Those skilled in the art will understand, and know how to choose and configure the data collecting device 36, the input data interface 20, and the output data interface 34 for different applications, and these devices or interfaces do not apply in any way to limit the invention.

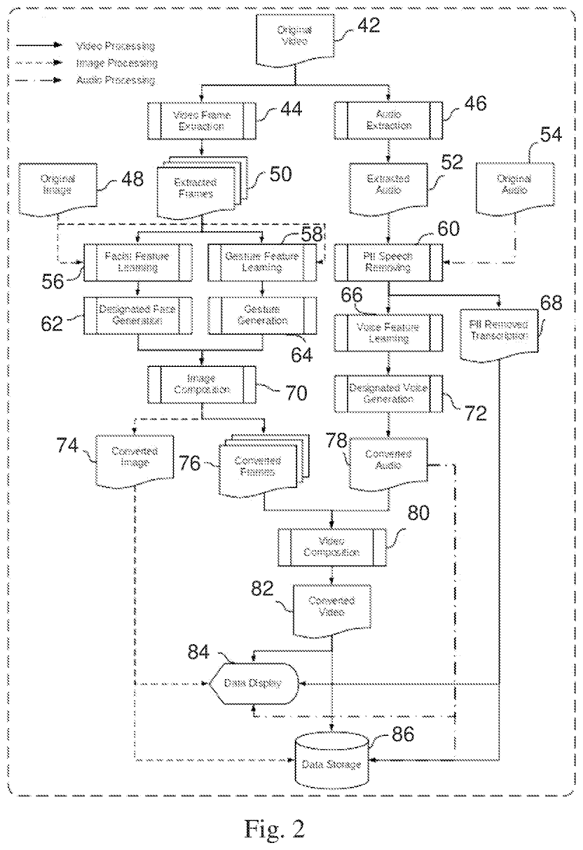

Turning to FIG. 2, a data processing method for removing part or all of PII in a human-related video data will now be described. The method may be executed using the data processing system 30 described above, but it may also be executed on other data processing systems in breath of the invention. Various blocks shown in FIG. 2 may stand for different status of data, sub-modules in the data processing system, and/or method steps of data processing. For instance, a same block in FIG. 2 or subsequent figures may refer to both a sub-module and a method step conducted using that sub-module.

The method in FIG. 2 starts by providing an original data which is the original video 42 to the data processing system (e.g. the original data is received by the data input module 24 of the data processing system 30 in FIG. 1), and the original video 42 contains at least a video part and an audio part, which are respectively extracted from the original video 42 in Steps 44 and 46. In Step 44, the video part contained in the original video 42 is extracted as a sequence of video frames 50, and in Step 46, the audio part is extracted as an extracted audio 52. Each one of the video frames 50 as understood by skilled persons is equivalent to an image. The extracted audio 52 and the extracted video frames 50 will then be processed separately.

In Step 56, the extracted video frames 50 are used for detecting a face of a human by a facial feature learning module. Besides the video frames 50, FIG. 2 also illustrates that original image(s) 48 may be provided to the facial feature learning module separately/in combination with the video frames 50. The original image 48 is provided as a separate input from the original video 42 but they may be correlated (e.g., the original image 48 illustrating a background of the scene in the original video 42). As mentioned above the video frames 50 is each equivalent to an image so in terms of face feature learning, the video frames 50 and the original image 48 are processed in the same way.

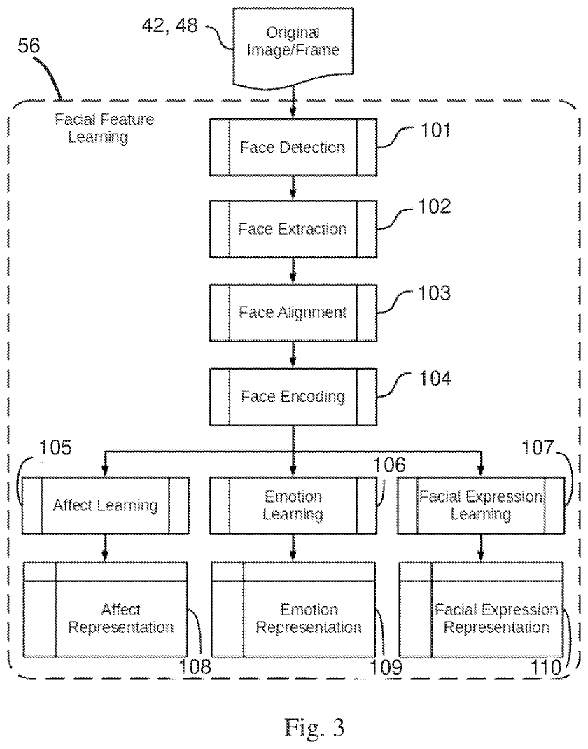

Details of the facial feature learning module and its operation method in Step 56 are shown in FIG. 3. The dash-line box in FIG. 3 represents the facial feature learning module which contains various sub-modules represented by the blocks in FIG. 3. The facial feature learning module utilizes machine-learning methods from the original image 48 and/or extracted video frames 50, and is adapted to detect, extract, and learn affect, motion, and other facial expression representations, where these vector representations are used for later guidance to a designated face generating module (represented by the block 62 in FIG. 2). In particular, as shown in FIG. 3, the original image 48 and/or the extracted video frames 50 as inputted to the facial feature learning module is firstly proceed for face detection in Step 101, which determines whether the original image 48 and/or the extracted video frames 50 includes any human face or not. The detection can be performed by using any existing software, API, and trained machine learning approaches, including but not limited to feature-based approaches, statistical modeling approaches, and neural network approaches. If there is a face detected in Step 101, the image/frame with detected face information is then processed in Step 102 for face extraction. If there is no face detected in Step 101, then the rest of the method shown in FIG. 3 will not be executed further.

In the Step 102, a face extraction module crops a face area from the original image 48 or extracted video frame 50. Since the non-PII facial feature learning process only concerns features (e.g., affect, emotion, and all other facial expressions) from the face area, in Step 102 it will remove all background information by cropping out the face area. Next, the extracted face image is proceed for face alignment in Step 103 by a face alignment module. In this step the cropped face(s) may be resized and aligned to a unified standard. Using video frames 50 as an example, the face alignment operation aligns facial landmarks in a continual sequence which helps a subsequent feature learning and encoding module to learn continual face motions (e.g., yaw, pitch, and roll). The face encoding process conducted by the feature learning and encoding module is shown in Step 104. When the face information is encoded, it is then proceed by three learning sub-modules in parallel, which are an affect learning module, an emotion learning module and a facial expression learning module. The affect learning module in Step 105 learns the affect representation 108 according to face pose and angle features. The emotion learning module in Step 106 learns the emotion representation 109 according to emotional features. Other face features (e.g. eyes and mouth motion) which is the facial expression representation 110 can be learned by the facial expression module in Step 107. Each of the affect learning module, the emotion learning module and the facial expression learning module may use encoders from task-specific and well-trained computer vision models as known in the art that are designed for respective purposes, e.g., encoder-decoder or decoder-only machine learning models, generative adversarial networks, and diffusion models.

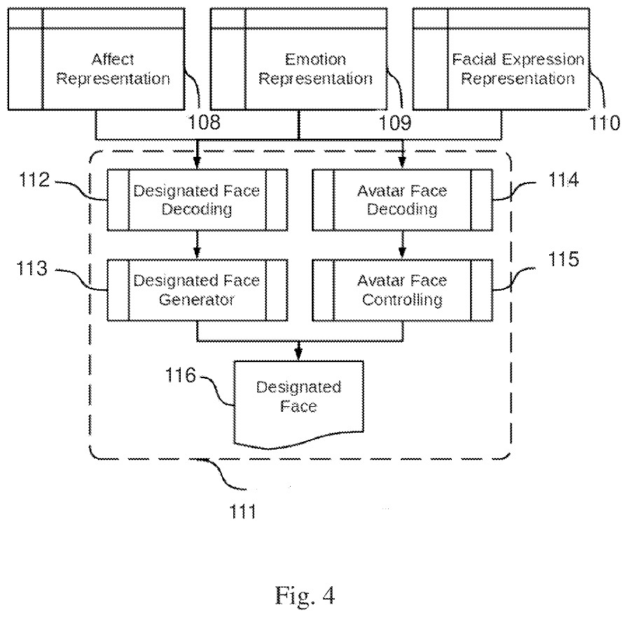

After the facial feature learning module, the designated face generating module in FIG. 2 and its operation in Step 62 will now be described. FIG. 4 best illustrates the designated face generating module 111 and its sub-modules. The previously generated affect representation 108, emotion representation 109 and face features or expressions 110 which are vector representations are inputted to the designated face generating module 111, but within the designated face generating module 111 there are more than one processes that can be selected. In particular, based on the various facial representations 108, 109 and 110, a designated face can be generated, and/or an avatar face can be generated. The designated face generation module has a well-trained machine learning model (e.g., key point capture and mapping) consisting of several layers, and if a designated face is desired, then the representations 108, 109 and 110 are inputted into a model inference module which in Step 112 decodes the representations 108, 109 and 110, and generates a designated face 116 and/or designated portrait and background (not shown) by a designated face generator in Step 113. The designated face is one face or a set of faces being normally the average of some collected faces or pre-selected faces that have gender, age, race, and/or other biases removed. The designated portrait shows the designated face with one or a set of unified dressing, hairstyle, stature, etc. The designated background unifies the lighting and/or surroundings for all images and videos. The designated face, portrait and background can be individually chosen by a user, created by the user, randomly selected or generated by the system with an algorithm that takes into the preference of the user.

Instead of collected faces or pre-selected faces that are often real faces, the designated face can also be an avatar or face of virtual characters (e.g. animated faces), and the avatar face is generated through another method flow path in FIG. 4. It should be noted that for the same original video, different detected faces in the video can be individually transformed to real or animated faces. The designated face generation module 111 has sub-modules to deal with avatar or virtual character faces, in which the face generator model is replaced by an avatar face decoding module 114 and an avatar face controlling module 115 to control the face expressions of the avatar or virtual character's face. While generating avatar faces, the affect, emotion, and facial expression information from the original face (which was detected, extracted and encoded) is decoded and mapped by the avatar face decoding module 114 and the avatar face controlling module 115 to an avatar face model which may be created by any 3-D editors.

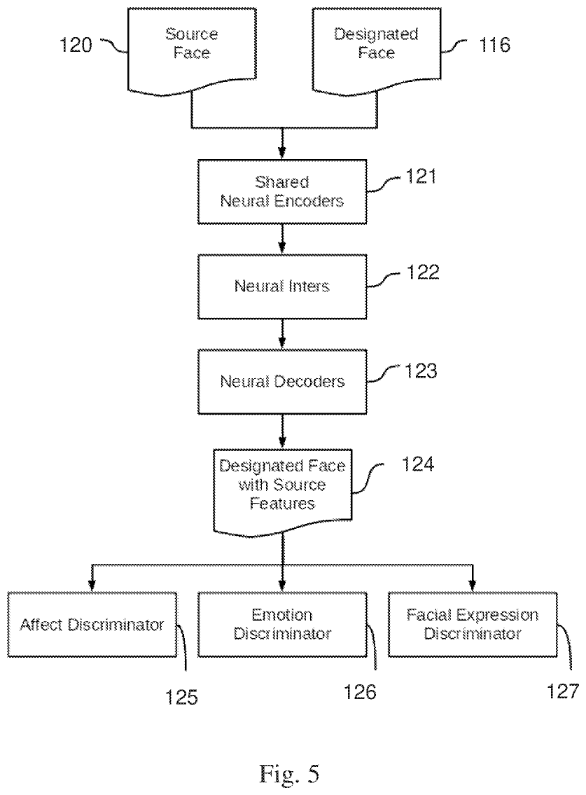

The designated face generation module 111 may consist of neural networks as the encoder-decoder structure, which as shown in FIG. 5 may also include shared encoders 121, inter layers 122, and multiple decoders 123. The designated face generating module is co-trained with the encoders 121 that are used for face feature learning, by sharing the weight. Before being applied to the data processing system, a generator model should be trained by using generative adversarial networks or other neural methods as known in the art. The training data include source faces 120 and designated faces 116 in a variety of facial expressions. The designated faces 116 could be obtained for example using the process shown in FIG. 4. During the training process, for example if the model employs generative adversarial networks, the generated designated faces will be judged by different discriminators (see affect discriminator 125, emotion discriminator 126, and facial expression discriminator 127 in FIG. 5) in Step 124 to check whether generated face features of the designated faces are consistent with those of the source faces 120. The representations 108, 109, and 110 learned by the non-PII facial feature learning module are decoded in Step 112 (see FIG. 4) by the trained generator model. The generator model in Step 113 generates the designated face that contains non-PII features synced with the original face.

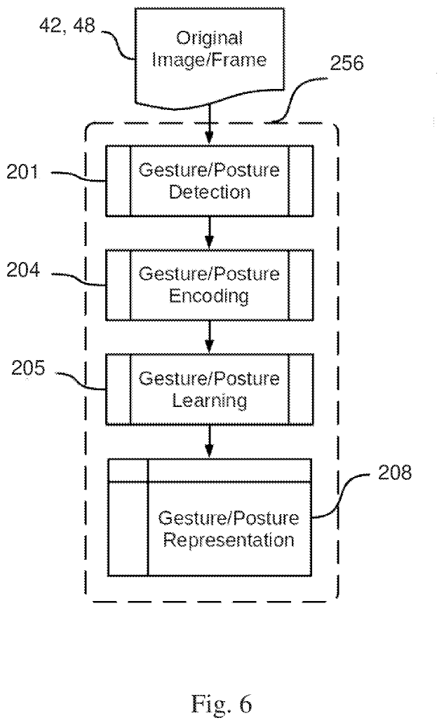

Next, gesture feature learning from the original image 48 and/or video frames 50 will be discussed. In Step 58 as shown in FIG. 2, a gesture feature learning module utilizes machine-learning methods and is adapted to detect, extract, and learn gesture and posture representations for later guidance to a gesture generation module 64. Details of the gesture feature learning module and its operating principle are shown in FIG. 6. As shown in FIG. 6, the gesture feature learning module consists of several functional and processing sub-modules to convert the original image 48 and or video frames 50 into gesture and posture vector representations 208. In particular, the original image 48 and/or the extracted video frames 50 as inputted to the gesture feature learning module is firstly proceed for gesture/posture detection in Step 201, which determines whether the original image 48 and/or the extracted video frames 50 includes any a gesture or a posture of a human or not. Human-related videos often involve gestures and postures which express many non-PII yet useful information for machine learning models 32, human annotation tools 38, and other potential usages 40 (see FIG. 1). Thus, in Step 201 a gesture detection module of the gesture feature learning module could determine whether the image 48 or frame 50 contains any gesture and body motion. The detection can be performed by using existing software, API, and trained machine learning approaches as known in the art, e.g., feature-based approaches, statistical modeling approaches, and neural network approaches. If there is a gesture or posture detected in Step 201, the image/frame with detected gesture/posture information is then processed in Step 204 for gesture/posture encoding. If there is no gesture or posture detected in Step 201, then the rest of the method shown in FIG. 6 will not be executed further.

After the gesture/posture is encoded, in Step 205 the recognized gesture and posture can be learned by a gesture learning module and encoded in Step 204 into gesture/posture representations 208 which are vector representations. The gesture learning module may use the encoder from well-trained computer vision models, as known in the art, designed for dynamic gesture and posture learning purposes, e.g., encoder-decoder or decoder-only machine learning models, generative adversarial networks, and diffusion models.

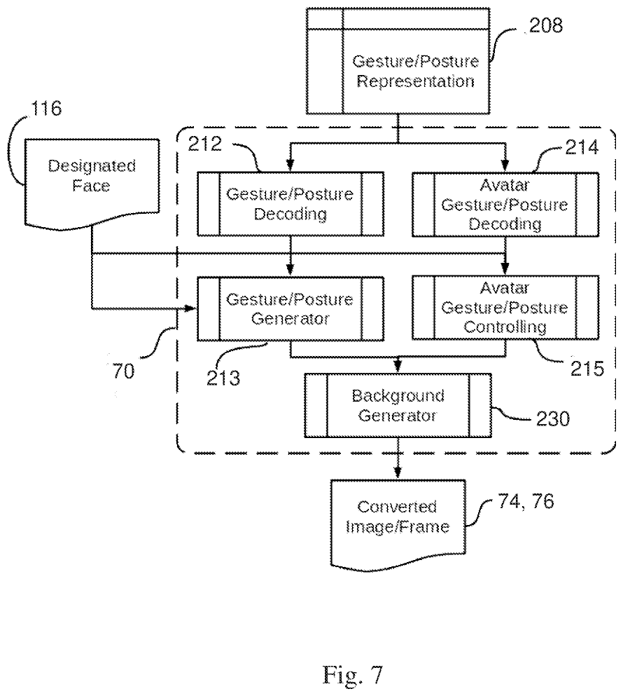

The gesture generation module 64 has a well-trained machine learning model consisting of several neural layers. As best shown in FIG. 7, a model inference module decodes the previously generated gesture/posture representations 208 in Step 212, and generates a designated gesture/posture in Step 213. The generated gesture/posture is then used to compose designated portraits as converted image 74 (in accordance with the original image 48) and/or converted video frames 76 (in accordance with the original video 42). Alternatively or in addition to designated posture or gesture, the gesture generation module has sub-modules to deal with avatar or virtual character gestures and posture, in which the gesture generator model is replaced by an avatar gesture/posture decoding module 214 and an avatar gesture/posture controlling module 215, which are adapted to control the gestures and postures of the avatar or virtual character.

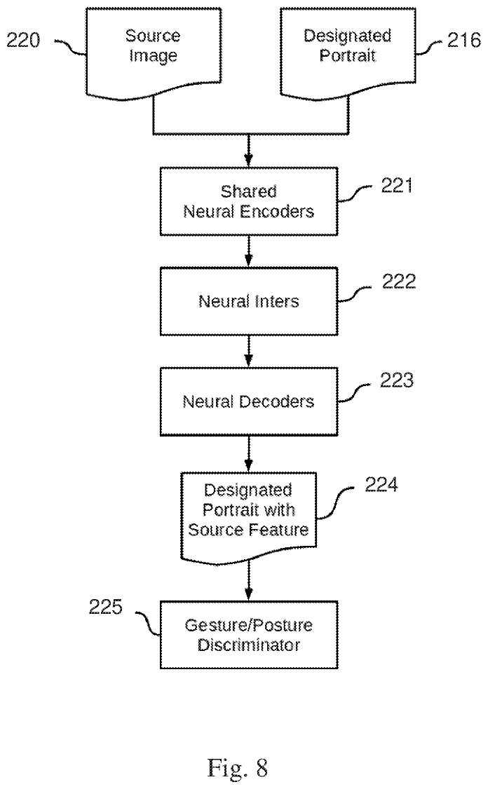

Before being applied to the data processing system, the gesture generator model, as shown in FIG. 8, should be trained by using generative adversarial networks or other neural methods as known in the art. The training data include source images 220 and designated portraits 216 in a variety of gesture and posture expressions. Generated designated portraits 224 with source features are judged by the gesture/posture discriminator 225 to check whether the generated gesture and posture features in the generated designated portrait 224 are consistent with those of the source images 220. The gesture generator model may consist of neural networks as the form of encoder-decoder structure, which may also include inter layers 222, multiple encoders 221 and decoders 223. The gesture generation module 64 is co-trained with the encoders 221 that are used for gesture feature learning, by sharing the weight. The representation 208 learned by the gesture feature learning module is decoded in Step 212 (see FIG. 7) by the trained gesture generator model. The gesture generation model generates in Step 213 the stranded portrait containing gesture and posture features synced with the original image/frames. The gesture generation model can also generate in Step 230 a designated background to unify the lighting and surroundings of the image/frame. By now the designated face, gesture, and posture have all been generated, and they can be composed in Step 70 into converted image 74 or converted video frame 76. The converted image 74 with part of all of PII contained in the original image 48 removed can be outputted, for example be displayed to a user by a data display device (such as the data display device 28 in FIG. 1) in Step 84, or be stored in a data storage device (such as the data storage device 31 in FIG. 1) in Step 86. Examples of the visual PII include facial characteristics and shape, age, hair style, skin color, ethnicity, gender, clothing, wearables, height, body shape and fitness, and background environment.

Having described the conversion of image/video received at the data processing system, the descriptions now go to the removal of PII from the audio part of the original video 42. As mentioned before in FIG. 2 the audio part is extracted from the original video 42 in Step 46, and the extracted audio 52 is then processed for PII speech removing in Step 60, in which a PII speech removing module is adapted to remove the sensitive PII speech mentioned in the audio. In Step 66, a voice feature learning module consisting of several functional and processing modules then converts waveforms of the extracted audio 52 into different vector representations including a pitch & intensity representation 358, a speed of speech representation 360, and a fluency representation 362. Besides the extracted audio 52, FIG. 2 also illustrates that original audio 54 may be provided to the PII speech removing module separately/in combination with the extracted audio 52. The original audio 54 is provided as a separate input from the extracted audio 52 but they may be correlated, and they are processed in the same way.

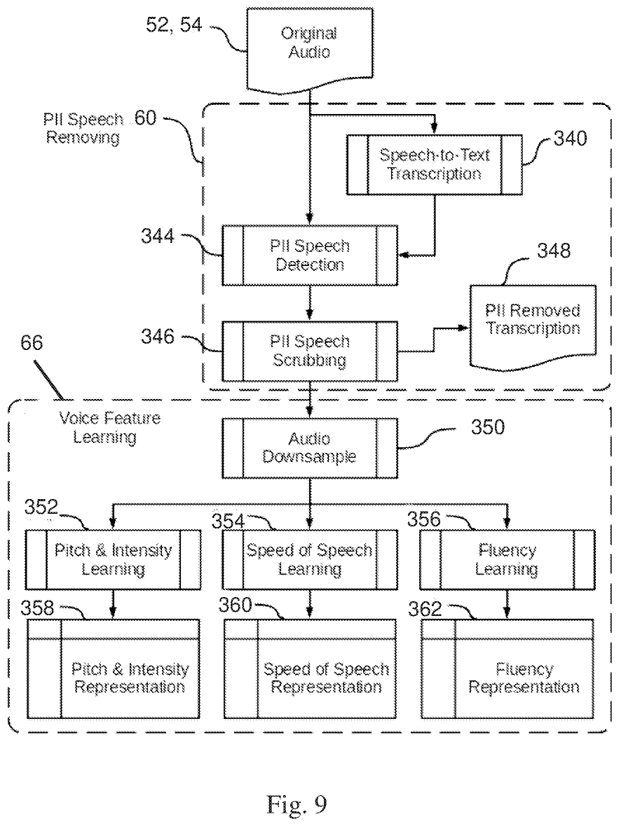

Human-related audio often contains two types of PII, namely, PII speech (name, gender, age, address, email, phone number, etc. mentioned in the audio) and voiceprint features (e.g., accent, waveform, amplitude, frequency, and spectrum) to identify the speaker. The extracted audio 52 or original audio 54 is transcribed in Step 340 (see FIG. 9) to text by speech-to-text software, API, or well-trained speech-to-text machine learning models as known in the art before further processing. Next, a PII speech detection model is used for conducting a PII speech detection in Step 344, which is a dual-modal machine learning model trained to automatically identify and segment the PII speech patterns with start and end timestamps in the audio, with the help of transcriptions obtained from Step 340. The segmented audio waveform of PII speech is then scrubbed in Step 346 by replacing the waveform with nondescript audio (e.g., flat tone, white noise, or silence). In Step 346 the identified PII word or phrase in the transcriptions will be also replaced by no-meaning characters, which results in the generation of PII-removed transcriptions 348.

After the PII speech is obtained, the descriptions then go to the voice feature learning module and its operation in Step 66 (see FIG. 2). The audio with detected PII speech is firstly downsampled in Step 350. Then, a voice pitch and intensity learning module in Step 352 learns the pitch & intensity representation 358 according to voice characteristics including pitch, intensity, pronunciation, etc. A speed of speech learning module on the other hand learns the speed of speech representation 360 in Step 354 according to the voice characteristics including pace, rate, rhythm, fluency, etc. Similarly, a fluency of speech learning module learns the fluency representation 362 in Step 356 according to the voice characteristics including pace, rate, rhythm, fluency, etc. Both the speed and fluency learning module, and the voice pitch and intensity learning module, may use encoders from well-trained computer audio models, as known in the art, which are designed for speed and fluency learning purposes, e.g., encoder-decoder or decoder-only machine learning models, generative adversarial networks, and diffusion models.

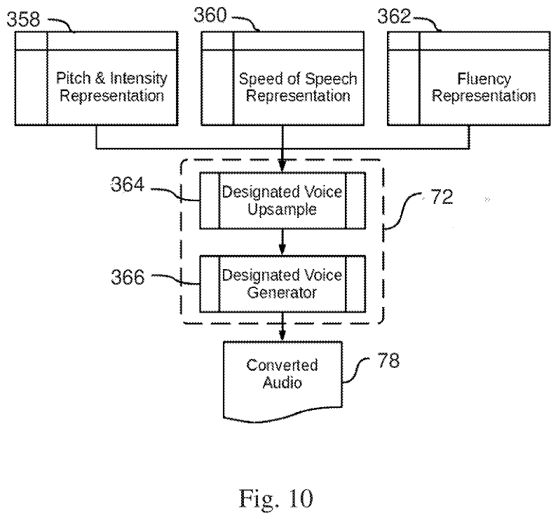

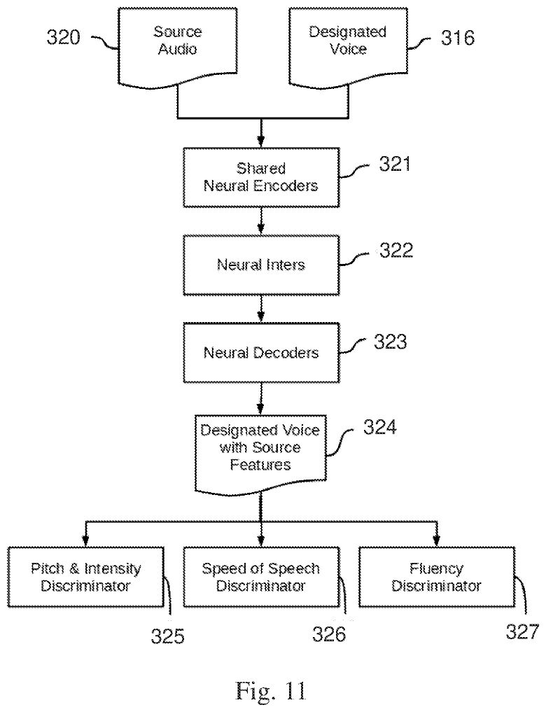

Turning to FIG. 10 which shows that the designated voice generation module has a well-trained machine learning model consisting of several neural layers. A model inference sub-module decodes/upsamples the representations 358, 360, 362 in Step 364, and a designated voice generator generates designated voice in Step 366. The designated voice(s) is normally one or a set of the average of some collected voices or the pre-selected voice. The designated voice generator may consist of neural networks as the form of encoder-decoder structure, which may also include (see FIG. 11) inter layers 322, multiple encoders 321 and decoders 323 to downsample and upsample the audio waveform. In particular, the representations 358, 360, 362 as learned by the voice feature learning module are decoded/upsampled by a trained designated voice generator model. The generator model in Step 366 generates the stranded voice as converted audio 78 that contains voice features synced with the original audio 46, 54.

The designated voice generator is co-trained with the encoders 321 that are for voice feature learning by sharing the weight. Before it is applied to the data processing system, the designated voice generator model should be trained by using generative adversarial networks or other neural methods as known in the art. The training data include (see FIG. 11) source audio 320 and designated voice 316 in a variety of voice expressions. The designated voice 316 could be those generated using the method shown in FIG. 10. The generated designated voice will be judged by the pitch and intensity discriminator 325, the speed of speech discriminator 326, and the fluency discriminator 327 to check whether generated voice features in the generated designated voice are consistent with those in the source audio 320.

So far in the method of FIG. 2, all the converted data have been generated including the converted image 74, the converted frames 76, the converted audio 78, and the PII-removed transcriptions 68. The converted image 74, the converted audio 78 and the PII-removed transcriptions 68 can be directly stored in Step 86, and displayed in Step 84, using for example the data storage device 31 and the data display device 28 in FIG. 1 respectively. However, for a converted video to be generated, stored and displayed, the converted frames 76 and the converted audio 78 may be combined in Step 80 to compose the converted video. The converted video may then be stored in Step 86 and or displayed in Step 84. The process based on the converted frames 76 and the converted audio 78 to compose into the converted video may be based on integrating and utilizing the frame padding and frame audio alignment methods.

One can see that the methods illustrated in FIGS. 2-11 provide separation generation of the face and gesture, which enables a data processing system to blend (e.g., in Step 70 of FIG. 2) the face, gesture, and background for the sake of remaining consistent complexion. The data processing system may use colour transfer algorithms, Poisson blending, and sharpening algorithms (e.g. super-resolution models), as known in the art, to compose the images. Moreover, extracted frames from the video may be not all converted as some frames may not contain faces and gestures. Therefore, some average frames are inserted and padded during video composition into the frame sequence to be consistent with the original video and audio. The converted and padded frame sequence is then aligned with the converted audio frame by frame during video composition (e.g., in Step 80 of FIG. 2) to compose the final converted video.

The method solves the problem of having traces of original human PII in the parameters of the trained machine learning model by removing the PII from the training data. This enhances the security of the model and prevents reverse engineering of machine learning models to obtain personal information. The method can also be applied on the human video, audio and images for inferences of machine learning models trained with or without PII-removed data. This allows the personal information to be moved, or getting data to be normalized before inferences, allowing standardizing or bias removal in the inference data.

On the other hand, storage of PII of videos in conventional art was problematic. It includes restricting access, encrypting the files, establishing a good departing employee policy. One of the most important rules is to delete the PII when not using the information. One can see that the method of FIG. 2 allows the PII from the videos to be removed but keeps non-PII features and allows the risks of storage to be significantly reduced.

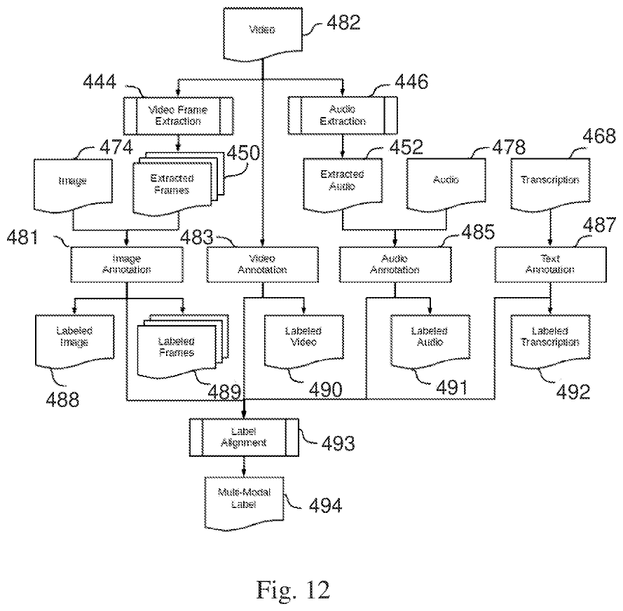

Turning to FIG. 12, a multi-modal data annotation module according to another embodiment will now be described which is in addition to data processing systems such as the one illustrated in FIG. 2. The multi-modal data annotation module can be used as the data annotation tool 38 in the infrastructure in FIG. 1, and is adapted to further process converted video 482, converted image 474, converted audio 478, and/or PII-removed transcription 468 which are generated/converted and with part or all PII removed using for example the method of FIG. 2. The multi-modal data annotation module is adapted to perform image, video, audio, and text annotation (e.g., segmentation, classification, tracing, timestamp, transcription, tagging, and relationship mapping) locally, remotely, and distributedly to generate single/multi-modal aligned human labels.

To start with the annotation, the converted video 482 can be extracted into extracted frames 450 in Step 444, and into extracted audio 452 in Step 446, by using the same or similar extraction modules as in the data processing system shown in FIG. 2. The image annotation module 481 is adapted to process images (e.g. converted images 474 or extracted frames 450). Human annotators can perform segmentation (e.g., bounding box, polygon, and keypoint), image-level/fine-grained classification, and image transcription through the image annotation module 481. The video annotation module 483 is adapted to process videos (e.g. converted video 482) directly. Human annotators can perform segmentation (e.g., bounding box, polygon, keypoint, and timestamp), tracing, video clip/frame-level and fine-grained classification, and video transcription through the video annotation module 483. The audio annotation module 485 is adapted to process audios (e.g. converted audio 478). Human annotators can perform segmentation (e.g. timestamps), audio-level/fine-grained classification, and audio transcription through the audio annotation module 485. The text annotation module 487 is adapted process any text (e.g. PII-removed transcription 468). Human annotators can perform tagging, document-level/fine-grained classification, and relationship/dependency mapping through the module text annotation module 487. All the annotation modules 481, 483, 485, 487 described herein may each be implemented on local, remote and/or distributed platform. Lastly, all the labels generated by the annotation modules 481, 483, 485, 487 can be aligned in Step 493 (e.g., time alignment, position alignment, person/object alignment, etc.) to form the multi-modal labels accordingly for multi-modal analysis and processing.

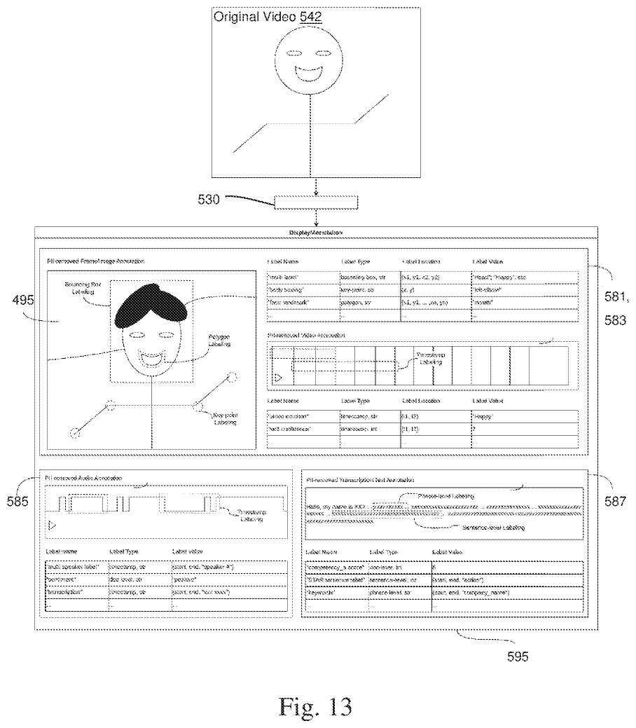

FIG. 13 shows an exemplary user interface for conducting multi-modal data annotation, where an original video 542 after removing PII through a data processing system 530 (which for example is similar to the one shown in FIG. 2) is being annotated on the user interface 595. Different annotation tools are presented on a display device for the user to conduct human annotation, including an image annotation module 581, a video annotation module 583, an audio annotation module 585, and a text annotation module 587, all of which could be similar to their counterparts in FIG. 12 as described above.

Next, other parties in the infrastructure shown in FIG. 1 will be briefly described. The data collecting device 36 and other device(s)/application(s) 40 in some embodiments could be provide part or all of the following functionalities: login section control, display of pages showing the existing tasks and functions to create new tasks, an upload video button, an uploaded video canvas, one or more designated face, voice, one or more avatar; selecting some or all of the PII(s) to be removed without specifying the designated face, voice and avatar; page(s) that show the generated video and voice; and tools to edit and share the processed video. The above functions may be presented as a software Development Toolkit (SDK). The data processing system in some embodiments may generate an API (Application Programming Interface) key, so that users can upload the original video/image/audio in batch mode or stream mode, and select the settings using API and get the generated video/image/audio using API with the key. There may be provided functionalities to safely remove all original videos in an irreversible manner. The API may also have default values so that the user can just send the video, audio or images in the request and get some or all of the PII removed to a default designated face, voice and avatar as response. The user of the API can then just trigger the API with a button in the user interface of the applications.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

Embodiments of the invention provide highly efficient, effective, reasonable, and explainable systems and methods for PII protection within human video, image, audio, and transcription. In the descriptions above, exemplary embodiments include process steps and/or operations and/or instructions described herein for illustrative purposes in a particular order and/or grouping. However, the particular order and/or grouping shown and discussed herein is illustrative only but not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. For example, those of skill in the art can perform some partial conversion (e.g. eyes and mouth) or keep some selected PII (e.g. PII in the background) while processing the human video or image. Consequently, the particular order and/or grouping of the process steps and/or operations and/or instructions discussed herein does not limit the scope of the invention as claimed below. Therefore, numerous variations, whether explicitly provided for by the specification or implied by the specification or not, may be implemented by one of skill in the art in view of this disclosure.

In the method shown in FIG. 2, all of video, audio, image are shown to be processed in parallel, and similarly in FIG. 12, all of video, audio, image and transcriptions are shown to be annotated parallel. Those skilled in the art should realize that these illustrations are for the purpose of description only, and in practical implementations not all types of data need to be processed at the same time. The aforementioned PII removal with image/frames, audio, etc. may work independently or together to process the human multimedia. For example, the data processing system could process original video without any audio part. In another example, one may only remove PII from a single human image or a piece of human speech. The scope of PII can be defined by users, i.e., the PII removals can happen at different levels in human multimedia, such as only partially removing PII, e.g., on the face, but keeping remaining, e.g., background, hairstyle, and gesture.

There are many applications of the data processing systems according to embodiments of the invention, include but not limited to human behaviour research, training and education, consumer behaviour study, human interaction study, customer service, customer surveys, surveillance, opinion & market survey, building facility and city management, social media, advertising, job and presentation training, job candidate assessments, job appraisals, occupation therapy, psychiatric therapy, well-being training, robotics, human behaviour, affect and characters annotation or general machine learning processing purposes. Individuals and businesses that may be benefited from the data processing systems include data annotation companies, AI and IT technology suppliers and vendors, data and it security companies, corporates, hospitals, clinics and authority that have sensitive data, clinics, banks, insurance firms, universities and researchers.

The original data to data processing systems according to embodiments of the invention may be human video, image, and audio that can be either data in a single file or data stream(s) in different resolution, sample rate, frame per second, bit per second, and file format which come from different devices including but not limited to smartphone, computer, web camera, microphones, security camera, Internet-of-Things and closed-circuit television system.

All or portions of the methods in accordance with the embodiments may be executed in one or more computing devices including server computers, personal computers, laptop computers, and mobile computing devices such as smartphones and tablet computers.

The embodiments include computer storage media, transient and non-transient memory devices having computer instructions or software codes stored therein which can be used to program computers or microprocessors to perform any of the processes of the present invention. The storage media, transient and non-transitory computer-readable storage medium can include but are not limited to floppy disks, optical discs, Blu-ray Disc, DVD, CD-ROMs, magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in a distributed fashion by one or more processing devices interconnected by a communication network, such as an intranet, WAN, LAN, the Internet, and other forms of data transmission medium.

What is claimed is:

1. A method for processing personal video data, comprising the steps of
a) receiving an original video data;
b) extracting video frames and an audio from the original video data;
c) identifying personal identifiable information (PII) features as well as non-PII features in both the video frames and the audio;
d) extracting the non-PII features from the video frames and the audio;
e) using the extracted non-PII features, composing a converted video data; and
f) outputting the converted video data.

2. The method of claim 1, wherein step c) further comprises detecting one or more of a face and a body characteristic from the video frames.

3. The method of claim 2, wherein step d) further comprises
g) encoding a detected face or a detected body characteristic;
h) learning the detected face or the detected body characteristic.

4. The method of claim 3, wherein step h) further comprises
i) learning an affect of the detected face;
j) learning an emotion of the detected face; or
k) learning a facial expression of the detected face.

5. The method of claim 3, wherein the detected body characteristic comprises one or more of a body motion, a posture, and a gesture.

6. The method of claim 2, wherein step e) further comprises
l) generating a designated or random face based on a detected face, or a designated or random body characteristic based on a detected body characteristic;
m) composing the converted video data based on the designated or random face or the designated or random body characteristic.

7. The method of claim 6, wherein the designated face is generated using a neural network as an encoder-decoder structure.

8. The method of claim 2, wherein step e) further comprises
n) generating an avatar face;
o) applying non-PII features of the face to the avatar face;
p) composing a converted video data based on the avator face and/or the generated body characteristic.

9. The method of claim 1, wherein step c) further comprises
q) transcribing the audio into a textual transcription;
r) detecting the PII features from the audio and the transcription; and
wherein step d) further comprises
s) learning an audio feature from the audio.

10. The method of claim 9, wherein the audio feature is pitch, intensity, speed or fluency of speech.

11. The method of claim 1, wherein step e) further comprises composing the converted video data using face, avatar, portrait, background, and human voice as designated or randomized.

12. The method of claim 1, further comprises the step of performing data annotation on the converted video data by a multi-modal data annotation module.

13. A system for processing personal video data, the system comprising:
a) at least one processor; and
b) a non-transitory computer readable medium comprising instructions that, when executed by the at least one processor, cause the system to:
i) receive an original video data;
ii) extract video frames and an audio from the original video data;
iii) identify personal identifiable information (PII) features as well as non-PII features in both the video frames and the audio;
iv) extract the non-PII features from the video frames and the audio;
v) using the extracted non-PII features, composing a converted video data; and
vi) outputting the converted video data.

14. A non-transitory computer-readable medium comprising instructions that, when executed by at least one processor, cause a computer system to:
a) receive an original video data;
b) extract video frames and an audio from the original video data;
c) identify personal identifiable information (PII) features as well as non-PII features in both the video frames and the audio;
d) extract the non-PII features from the video frames and the audio;
e) using the extracted non-PII features, compose a converted video data; and
f) output the converted video data.

15. A method for processing personal audio data, comprising the steps of
a) receiving an audio;
b) identifying personal identifiable information (PII) features as well as non-PII features in the audio;
c) extracting the non-PII features from the audio;
d) using the extracted non-PII features, composing a converted video data; and
e) outputting the converted audio data.

16. The method of claim 15, wherein step b) further comprises
f) transcribing the audio into a textual transcription;
g) detecting the PII features from the audio and the transcription; and
wherein step c) further comprises
s) learning an audio feature from the audio.

17. The method of claim 16, wherein the audio feature is pitch, intensity, speed or fluency of speech.
